(19) United States
(12) Patent Application Publication
(10) Pub. No.: US 2026/0095354 A1
(43) Pub. Date: Apr. 2, 2026

(54) SYMBOL TRACKING AND TIMING ESTIMATION

(71) Applicant: AMERGINT Technologies Inc., Colorado Springs, CO (US)

(72) Inventors: Wayne D. Music, Colorado Springs, CO (US); Bryan E. Usevitch, Colorado Springs, CO (US)

(21) Appl. No.: 19/347,077

(22) Filed: Oct. 1, 2025

Related U.S. Application Data
(60) Provisional application No. 63/701,914, filed on Oct. 1, 2024.

(51) Int. Cl. H04L 27/156; H04L 27/16

(52) U.S. Cl. CPC H04L 27/156; H04L 27/16

(57) ABSTRACT

Systems include a receiver configured to detect signals corresponding to a stream of digital symbols, a signal demodulator coupled to the receiver and configured to process an incoming stream of digital symbols, and a computing device connected to the receiver and to the signal demodulator, and featuring a set of software instructions that, when executed by the computing device, causes the computing device to determine an estimated time delay associated with the stream of digital symbols, transmit control instructions to the signal demodulator to configure the signal demodulator according to the estimated time delay, and process at least a second subset of the stream of digital symbols using the configured signal demodulator.

### CROSS-REFERENCE TO RELATED APPLICATIONS

This application claims priority to U.S. Provisional Patent Application No. 63/701,914, filed on Oct. 1, 2024, the entire contents of which are incorporated herein by reference.

### BACKGROUND

Radio-frequency communication systems receive signals at a variety of transmission frequencies. When the frequency and phase of a particular symbol stream is known and relatively constant, detection of an incoming signal and extraction of information encoded in the signal is generally straightforward. However, when the frequency and/or phase of an incoming stream of symbols is not known, detection of the symbol stream presents additional challenges and a significant amount of encoded information can be lost.

### SUMMARY

This disclosure features methods, systems, and tangible, computer-readable media with encoded instructions for performing blind detection of the frequency and/or phase of an incoming symbol stream. The methods, systems, and encoded instructions generally use complex, higher-order cumulants to analyze incoming symbol streams. Because higher-order cumulants are statistical in nature, they are less susceptible to symbol-to-symbol variations in timing than other methods for estimating frequency and phase of a symbol stream. Consequently, the cumulant-based methods, systems, and encoded instructions described herein are generally capable of reliably estimating the frequency and/or phase of a blind symbol stream after sampling a relatively small number of incoming symbols, compared with sampling requirements for more conventional symbol tracking methods. As such, the methods, systems, and encoded instructions described herein, when in use, result in comparatively faster lock-in on incoming symbol streams, and comparatively reduced data loss, relative to conventional methods.

In one aspect, the disclosure features systems that include a receiver configured to detect signals corresponding to a stream of digital symbols, a signal demodulator coupled to the receiver and configured to process an incoming stream of digital symbols, and a computing device connected to the receiver and to the signal demodulator, and featuring a set of software instructions that, when executed by the computing device, causes the computing device to determine an estimated time delay associated with the stream of digital symbols by: (a) for at least a first subset of the stream of digital symbols, determining two kurtosis values associated with the subset of the stream of digital symbols, where the first kurtosis value is associated with a first time delay value and the second kurtosis value is associated with a second time delay value different from the first time delay value; (b) selecting either the first or second time delay value according to the smallest associated kurtosis value; (c) selecting a new time delay value to replace either the first or second time delay that is not selected in step (b); (d) repeating steps (a)-(c) to determine the time delay value associated with a minimum kurtosis value among all time delays within a sampling range of time delay values; and (c) identifying the time delay value associated with the minimum kurtosis value as the estimated time delay; transmit control instructions to the signal demodulator to configure the signal demodulator according to the estimated time delay; and process at least a second subset of the stream of digital symbols using the configured signal demodulator.

Embodiments of the systems can include any one or more of the following features.

The set of software instructions, when executed by the computing device, can cause the computing device to: determine a variance of the selected time delay values; and identify the time delay value associated with the minimum kurtosis value as the estimated time delay based on a comparison between the determined variance and a threshold value of the variance.

The set of software instructions, when executed by the computing device, can cause the computing device to: determine an estimated phase associated with the stream of digital symbols; and transmit control instructions to the signal demodulator to configure the signal demodulator according to the estimated phase. The set of software instructions, when executed by the computing device, can cause the computing device to determine the estimated phase by: for at least a subset of the stream of digital symbols, calculating real and imaginary components of a kurtosis for a plurality of different phase values; and selecting the value of the phase that yields a minimum value of a sum of real and imaginary components of the kurtosis as the estimated phase. The set of software instructions, when executed by the computing device, can cause the computing device to select the value of the phase that yields a minimum value of a sum of real and imaginary components of the kurtosis by performing a gradient descent minimization to determine the minimum value of the sum of real and imaginary components of the kurtosis.

The set of software instructions, when executed by the computing device, can cause the computing device to determine an estimated frequency associated with the stream of digital symbols, and transmit control instructions to the signal demodulator to configure the signal demodulator according to the estimated frequency. The set of software instructions, when executed by the computing device, can cause the computing device to determine the estimated frequency by: for at least a subset of the stream of digital symbols, calculating real and imaginary components of a kurtosis for a plurality of different frequency values; and selecting the value of the frequency that yields a minimum value of a sum of real and imaginary components of the kurtosis as the estimated frequency.

Processing the at least a second subset of the stream of digital symbols using the configured signal demodulator can include extracting information from the at least a second subset of the stream of digital symbols.

The computing device can be configured to determine the estimated phase from the first subset of the stream of digital symbols. The computing device can be configured to determine the estimated phase from a third subset of the stream of digital symbols.

The set of software instructions, when executed by the computing device, can cause the computing device to process an additional stream of digital symbols using the configured signal demodulator, and extract information from the additional stream of digital symbols.

The set of software instructions, when executed by the computing device, can cause the computing device to determine a value of decoding error associated with the processed second subset of the stream of digital symbols, and determine, based on the decoding error, whether to determine a new estimate for the time delay associated with the stream of digital symbols. The set of software instructions, when executed by the computing device, can cause the computing device to repeat steps (a)-(c) for a fourth subset of the stream of digital symbols to determine a new estimate for the time delay associated with the stream of digital symbols, and transmit control instructions to the signal demodulator to configure the signal demodulator according to the new estimated time delay.

Embodiments of the systems can also include any of the other features described herein, including any combinations of features described individually in connection with different embodiments, unless expressly stated otherwise.

In another aspect, the disclosure features systems that include a receiver configured to detect signals corresponding to a stream of digital symbols, a signal demodulator coupled to the receiver and configured to process an incoming stream of digital symbols, and a computing device connected to the receiver and featuring a set of software instructions that, when executed by the computing device, causes the computing device to determine an estimated time delay associated with the stream of digital symbols by: (a) for at least a subset of the stream of digital symbols, filtering the subset of the stream of digital symbols according to a candidate time delay and determining a kurtosis value associated with the filtered subset of the stream of digital symbols; (b) repeating step (a) to determine a plurality of kurtosis values associated with different candidate time delays; and (c) identifying the candidate time delay value associated with the minimum calculated kurtosis value as the estimated time delay; transmit control instructions to the signal demodulator to configure the signal demodulator according to the estimated time delay; and process at least a second subset of the stream of digital symbols using the configured signal demodulator.

Embodiments of the systems can include any one or more of the following features.

The set of software instructions, when executed by the computing device, can cause the computing device to interpolate among the determined plurality of kurtosis values to identify a minimum kurtosis value that is smaller than any of the determined plurality of kurtosis values, and identify a time delay value associated with the minimum kurtosis value as the estimated time delay.

The set of software instructions, when executed by the computing device, can cause the computing device to determine an estimated phase associated with the stream of digital symbols. The set of software instructions, when executed by the computing device, can cause the computing device to determine the estimated phase by: for at least a subset of the stream of digital symbols, calculating real and imaginary components of a kurtosis for a plurality of different phase values; and selecting the value of the phase that yields a minimum value of a sum of real and imaginary components of the kurtosis as the estimated phase. The set of software instructions, when executed by the computing device, can cause the computing device to select the value of the phase that yields a minimum value of a sum of real and imaginary components of the kurtosis by performing a gradient descent minimization to determine the minimum value of the sum of real and imaginary components of the kurtosis.

The set of software instructions, when executed by the computing device, can cause the computing device to determine an estimated frequency associated with the stream of digital symbols. The set of software instructions, when executed by the computing device, can cause the computing device to determine the estimated frequency by: for at least a subset of the stream of digital symbols, calculating real and imaginary components of a kurtosis for a plurality of different frequency values; and selecting the value of the frequency that yields a minimum value of a sum of real and imaginary components of the kurtosis as the estimated frequency.

Processing the at least a second subset of the stream of digital symbols using the configured signal demodulator comprises extracting information from the at least a second subset of the stream of digital symbols.

The set of software instructions, when executed by the computing device, can cause the computing device to: transmit control instructions to the signal demodulator to configure the signal demodulator according to the estimated phase; and process the at least a second subset of the stream of digital symbols using the signal demodulator configured according to the estimated time delay and estimated phase.

The set of software instructions, when executed by the computing device, can cause the computing device to: transmit control instructions to the signal demodulator to configure the signal demodulator according to the estimated frequency; and process the at least a second subset of the stream of digital symbols using the signal demodulator configured according to the estimated time delay and estimated frequency.

Embodiments of the systems can also include any of the other features described herein, including any combinations of features described individually in connection with different embodiments, unless expressly stated otherwise.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the subject matter herein, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments are set forth in the accompanying drawings and the description below. Other features and advantages will be apparent from the description, drawings, and claims.

### BRIEF DESCRIPTION OF THE DRAWINGS

FIG. 1 is a schematic diagram showing a signal receiver and a plurality of signal transmitters.

FIG. 2 is a schematic diagram showing a group of polyphase filters applied to a symbol stream.

FIG. 3 is a graph showing kurtosis values as a function of symbol time offset.

FIGS. 4A-4D are a set of graphs showing two kurtosis values as a function of delay time index to locate the time index at which kurtosis is a minimum.

FIG. 5 is a flow chart showing a set of example steps that can be used to detect an incoming symbol stream.

FIG. 6 is a schematic diagram showing an example of a detection system.

FIG. 7 is a flow chart showing a set of example steps that can be used to determine lock-in error and trigger re-estimation of parameter values associated with an incoming symbol stream.

FIG. 8 is a schematic diagram showing an example of a signal demodulator.

Like elements in the figures are labeled with common reference signs.

### DETAILED DESCRIPTION

### Introduction

In radio-frequency communication systems, receiving, tracking, and decoding symbol streams is critical to extracting information. To recover data from a digitally modulated signal, synchronization to a received symbol stream must occur.

In established networks of transmitters and receivers where the locations and transmission parameters of transmitters are well known, tracking and decoding symbol streams during uni-directional and bi-directional communication is comparatively easier. However, in many circumstances, signal tracking is performed while a receiver is effectively blind to the number of transmitters and/or symbol stream transmission parameters such as the symbol frequency, phase, and number and location of transmitters. In these situations, there are a number of factors that make symbol timing synchronization (also known as symbol timing recovery, clock synchronization, and clock recovery) challenging.

First, in many circumstances, a communications link does not have continuous transmission. Instead, burst-mode transmissions occur. However, both the start and end of each burst are typically unknown. Second, symbol frequency, phase, and transmitter location may change during signal transmission, and to mitigate data loss, methods for symbol timing synchronization may have to adaptively account for such changes.

Blind symbol timing synchronization—which is typically a precursor to symbol classification and information decoding from a symbol stream-relies on accurate estimates of symbol frequency and phase to reduce data loss due to missed symbols, particularly in the presence of transmission noise. The methods, systems, and encoded instructions described herein can be used to perform symbol timing synchronization in an incoming signal (e.g., an incoming, unknown stream of symbols). Synchronization facilitates symbol tracking and detection. Incoming symbols that are tracked can subsequently be classified and the encoded information symbol streams can be extracted.

The methods, systems, and encoded instructions described herein perform symbol tracking by using complex cumulants (i.e., cumulants with real and imaginary components) to characterize an incoming symbol stream. As cumulants are fundamentally statistical in nature, they are particularly well suited to the characterization of symbol streams transmitted during burst-mode communication. In particular, the kurtosis-based techniques described herein combined with polyphase filtering allow determination of the extent of synchronization based on deviation from a normal distribution. For purposes of this disclosure, the kurtosis is defined as the normalized fourth-order cumulant of a random variable.

### Time Delay, Phase, and Carrier Frequency Estimation

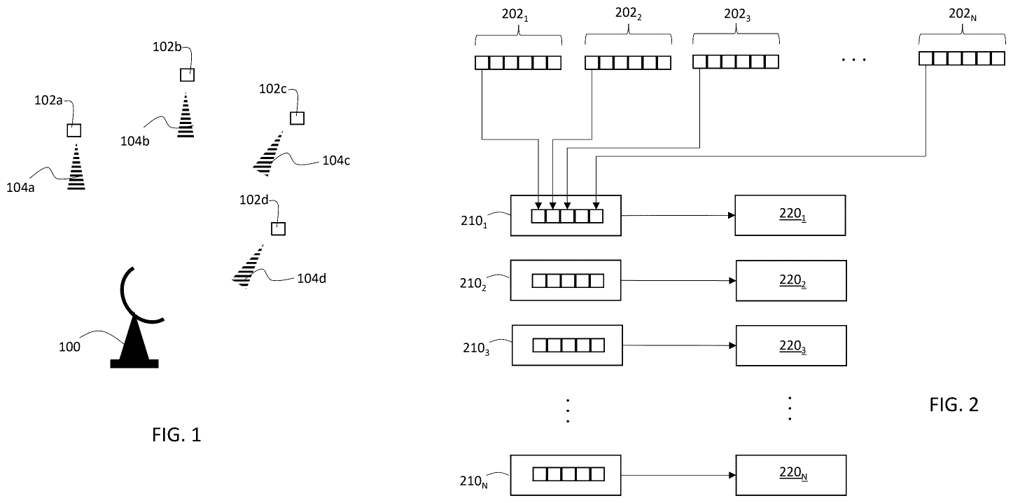

FIG. 1 is a schematic diagram showing a digital signal receiver 100 positioned to receive incoming digital signals in the form of a symbol stream. A plurality of signal transmitters 102a, 102b, 102c, 102d, . . . (where the number of such transmitters is unknown) transmits signals 104a, 104b, 104c, 104d, . . . (where the number of transmitted signals is unknown, and may be the same as, or different from, the number of transmitters). Transmitted signals reach receiver 100 and are detected as a stream of digital symbols. The symbols, which are encoded with information transmitted from the signal transmitters, constitute a stream of unknown frequency, phase, and timing offset. Achieving timing synchronization with the symbol stream is critical for receiver 100 to accurately track and decode the symbol stream.

It should be noted that in FIG. 1, a single receiver 100 receives an incoming signal. More generally, however, multiple receivers can be used (e.g., an array of receivers) to synchronize to, and decode, an unknown symbol stream.

A symbol stream of digital information in the form of a complex, baseband transmitted waveform x(t) encoding transmitter can be expressed as

$$x ( t ) = {\sum }_{k} {a}_{k} p ( t - {kT}_{s} ) \qquad [ 1 ]$$

and the carrier-modulated representation of x(t) is

$$x ( t ) = {\sum }_{k} {a}_{k} p ( t - {kT}_{s} ) {e}^{j {ω}_{0} t} \qquad [ 2 ]$$

where aₖ is the k-th complex-valued m-ary symbol drawn from a constellation of symbols with average symbol energy Eₛ, p(t) is a unit-energy pulse shape that spans 2L symbols, Tₛ is the reciprocal of the symbol rate, and ω₀ is the carrier frequency of the symbol stream (or, in some implementations, the remnant carrier frequency after down-conversion to either a baseband frequency or an intermediate frequency).

Receiver 100 detects the received signal, yielding a modulated version of the transmitted signal in which a delay τ and noise contribution n(t) are introduced. As such, the received signal r(t) can be represented as

$$r ( t ) = x ( t - τ ) + n ( t ) \qquad [ 3 ]$$

where τ is the delay relative to the receiver's time axis and n(t) is zero-mean, white Gaussian noise.

Receiver 100 filters the received signal with a matched filter whose impulse response is h(t)=p(−t). The resulting output signal y(t)=r(t)*h(t) is sampled at the end of the symbol interval to produce the decision variable used for making the symbol decision (i.e., for classifying the symbol). This entails knowledge of both the symbol rate 1/Tₛ and also the sampling time within the symbol interval (e.g., the timing phase). These parameters can be determined via continuous time-processing, discrete-time processing, or both.

In the discrete-time implementation, a timing synchronizer receives data in the form of a symbol stream that has already been sampled, so symbol synchronization is better understood as an adaptive interpolation. In a sampled data receiver, the received signal is sampled at a rate 1/T that satisfies the Nyquist theorem and is N times the symbol rate 1/Tₛ (e.g., N=2 for a square-root raised cosine pulse shape). The samples r(nT) are then filtered by a discrete-time matched filter to produce N samples of the matched filter output during each symbol interval, where one of the samples is as close to y(kTₛ−τ) as possible, where τ is the true symbol time offset.

At the receiver, the signal is typically bandpass filtered after being down-converted to a baseband ω₀ or intermediate frequency ω₁≈ω₀. The resulting filtered and down-converted signal u(t) can be represented as

$$u ( t ) = {e}^{- j {ω}_{{1}^{t}}} \cdot r ( t ) = {\sum }_{k} {a}_{k} p ( t - {kT}_{s} - τ ) {e}^{j ( {ω}_{Δ} t + φ )} + {n}^{′} ( t ) \qquad [ 4 ]$$

where ω_{Δ}=ω₀−ω₁ is the residual carrier frequency offset and φ represents the phase delay. The signal u(t) is further processed by passing through the matched filter with a finite duration of (K−1)T, where K is an odd integer, thus giving the pulse-shaping function a representation in K samples. The signal passes through a matched filter with an estimated delay \hat{τ} and is rotated by an estimate of the offset frequency \hat{ω}_{Δ} to produce the signal

$$x ( t ) = {e}^{j ( φ + ( {ω}_{Δ} - {\hat{ω}}_{Δ} ) t )} \cdot {\sum }_{k} {a}_{k} {R}_{pp} ( t - {kT}_{s} - ( τ - \hat{τ} ) ) + z ( t ) \qquad [ 5 ]$$

where z(t) represents a noise contribution filtered through the MF, and Rₚₚ is the pulse auto-correlation function.

The objective of the timing delay estimation problem is to determine a value of \hat{τ} such that \hat{τ}=τ, thereby effectively eliminating intersymbol interference. The objective of the phase and carrier offset problem is to eliminate the complex rotation factor that appears in Equation (5).

A variety of methods can be used to solve the foregoing problems. However, it has been recognized that due to the statistical nature of an incoming symbol stream, cumulant-based analysis provides a number of advantages that can be exploited to determine the estimated delay \hat{τ}. In the following discussion, examples of methods involving the use of cumulants to determine \hat{τ} will be described. The general nature of cumulant-based approaches to determining \hat{τ} should be understood, however, and it should be appreciated that variations on the example methods described herein are also within the scope of this disclosure.

Suppose that a random variable χ possesses a moment-generating function M_{χ}(t). Then the function K_{χ}(t)=ln [M_{χ}(t)] is the cumulant generating function of χ. The kurtosis is the fourth order cumulant and the cumulants are the coefficients in the Taylor expansion of the cumulant generating function about the origin. The kurtosis of a real, zero-mean random variable y is defined as

$${C}_{40 , y} = 𝔼 [ yyyy ] = 𝔼 [ {y}^{4} ] - 3 {𝔼 [ {y}^{2} ]}^{2} = {M}_{40 , y} - 3 {M}_{20 , y}^{2} \qquad [ 6 ]$$

where [symbol] is the expectation operator. The kurtosis of a complex random variable y is

$${C}_{42 , y} = 𝔼 [ {yyy}^{*} {y}^{*} ] = 𝔼 [ {\vert y \vert}^{4} ] - 2 {𝔼 [ {\vert y \vert}^{2} ]}^{2} - {\vert 𝔼 [ {y}^{2} ] \vert}^{2} \qquad [ 7 ]$$

where * denotes the complex conjugate operator. The sample average is typically used to compute the expected value.

Several properties of the kurtosis are significant for purposes of the symbol tracking problems that are addressed in this disclosure. First, the kurtosis of a real or complex Gaussian random variable is zero. Non-Gaussian random variables have kurtosis values that are positive or negative. Negative kurtosis is a measure of how flat the peak of the variable's distribution is and how much the distribution's tails spread out from the mean value, compared to a normal distribution (Platykurtosis). Positive kurtosis measures how narrow and peaked the variable's distribution is, compared to a normal distribution (Leptokurtosis). Consequently, the kurtosis can be used as a measure of the extent to which the distribution of a random variable is Gaussian.

Variables for which the kurtosis is large in magnitude are highly non-Gaussian. As an example, a real variable with values in the range {±A±jA} for a quadrature phase shift keying (QPSK) encoding scheme has a complex kurtosis of −4A⁴ and is strongly non-Gaussian.

Second, for independent random variables x and y, the complex kurtosis of the linear sum of these variables is separable, with no cross-terms:

$${C}_{42} ( α x + β y ) = {\vert α \vert}^{4} {C}_{42 , x} + {\vert β \vert}^{4} {C}_{42 , y} \qquad [ 8 ]$$

For a received signal x that includes contributions from a random variable s (i.e., a symbol stream) and average white Gaussian noise (AWGN) n such that x=s+n, then C₄₂(x)=C₄₂(s).

As noted previously, one application of the methods described herein is to determine the value of \hat{τ} that effectively eliminates intersymbol interference. Intersymbol interference occurs when a detection channel has multi-path propagation and when the channel's response is nonlinear with its bandwidth less than the incoming signal's bandwidth. The incoming signal is thus distorted by the channel, causing signal pulses to spread in such a way that they interfere with adjacent signal pulses at a particular sampling instant. If a matched filter is down-sampled by L, it can be shown that its output is

$$y ( m ) = x ( mL ) = {e}^{j ( ( {ω}_{Δ} - {\hat{ω}}_{Δ} ) mLT + φ )} {s}_{m} {R}_{pp} [ ( K - 1 ) T - ( τ - \hat{τ} ) ] + {e}^{j ( ( {ω}_{Δ} - {\hat{ω}}_{Δ} ) kLT + φ )} {\sum }_{k \neq m} {s}_{m} {R}_{pp} [ ( K - 1 ) T + ( m - k ) {T}_{s} - ( τ - \hat{τ} ) ] \qquad [ 9 ]$$

The set of terms for which k≠m in Equation (9) represent the intersymbol interference. These terms will tend towards a Gaussian distribution in which the distribution in the tails will contain more data than in a normal distribution. The value of \hat{τ} such that \hat{τ}=τ, which effectively eliminates the intersymbol interference, is determined by computing and using the properties of the kurtosis. Both real and complex kurtosis values are determined from a sequence of data over which averaging occurs. As noted above, random variables with kurtosis far from zero have distributions which are highly non-Gaussian.

When the value of τ is determined such that \hat{τ}=τ, only the first term remains in Equation (9). The first term has a phasor rotation, but the complex kurtosis is unaffected by this rotation. The maximum output of a Nyquist pulse auto-correlation is 1 and occurs at the origin (e.g., t=0). Therefore, the effect of offset symbol timing Rₚₚ is to reduce the desired symbol estimate ax by an amount proportional to the symbol timing offset \hat{τ}−τ=ϵ_{Δ}. When this term is non-zero, there is distortion of the sampled symbol due to intersymbol interference due to the accumulation of contributions from all other symbols in the temporal neighborhood of the current symbol, up to the pulse group delay.

There is an analogy between the carrier phase and symbol timing offsets. Just like the phase is defined between −π and +π and everything else is wrapped around, the symbol timing offset is defined between −0.5 T and +0.5 T and everything else is wrapped around. Consequently, T is analogous in symbol timing to 2π in the phase domain.

It should be evident that while most symbol timing offsets produce a random distribution around a constellation point, the sample in the middle of the symbol interval T corresponding to ϵ_{Δ} contains some structure. In general, more spectral cancelation occurs for large excess bandwidths, and less spectral cancelation for smaller excess bandwidths. Consequently, symbol timing strategies that operate with 1 sample per symbol generally exhibit better performance when the excess bandwidth is smaller.

Because intersymbol interference is due to the accumulation of other symbols, as the number of terms increases, y(n) approaches a normal distribution according to the central limit theorem. The increasing accumulation is linear and monotonic (for a square-root raised cosine pulse, p(t)) as the value of ϵ_{Δ} departs increasingly from zero. By measuring the amount of accumulated interference from the output of the matched filter, symbol timing can be estimated by minimizing the accumulated interference. The complex kurtosis of the matched filter output (which is complex) is a measure of the accumulated interference.

By changing ϵ_{Δ}, the probability density function of the matched filter output, y(n), is controlled. When ϵ_{Δ}=0, y(n) is a phase-rotated m-ary QPSK symbol which is non-Gaussian. Consequently, the more non-zero the timing symbol offset becomes, the greater the accumulated interference, which forces the distribution of y(n) toward a Gaussian distribution.

When kurtosis of a random variable is most negative, the distribution of the variable is most non-Gaussian. Conversely, when the kurtosis is zero, the distribution is most Gaussian. Thus, by adjusting the sampling phase of the matched filter output to make the kurtosis most negative, ϵ_{Δ} will be closest to zero.

To implement the above strategy, multiple polyphase filters are used to estimate an appropriate value for the sampling phase that results in a timing delay of zero. FIG. 2 is a schematic diagram showing an example implementation of the method described above. In FIG. 2, a group of N polyphase filters are constructed, with each filter representing a different time delay ϵ_{Δ}. The last filter of the group, with index N, has a delay that corresponds to the sample period, ϵ_{Δ}=Tₛ.

Symbol data received by a receiver is arranged in M data blocks 202₁ . . . 202_{M}, each of which contains N elements. The first element of each block is distributed to the first matched filter 210₁, the second element of each block is distributed to the second matched filter 210₂, and so on, until the N-th element of each block is distributed to the N-th matched filter 210_{N}. It should be noted that the input data symbols to each matched filter do not have to be contiguous.

Each matched filter filters the data it receives, generating a corresponding matched filter output. The N matched filter outputs are then individually processed to calculate a complex kurtosis value for each filter output. The filter output with the most negative complex kurtosis value is selected. The delay associate with the corresponding matched filter that generated the selected output is chosen as the timing delay ϵ_{Δ} for which \hat{τ}−τ is most nearly zero.

In some implementations, to further refine the value of the timing delay ϵ_{Δ} (for example, when the incremental timing delay between successive matched filters is too large for precise determination of the optimum value of the timing delay), a discrete-time Fourier transform (DTFT) at the symbol time period can be used; the phase of the kurtosis curve can be calculated from the symbol rate. From the estimated phase, the most negative magnitude of the complex kurtosis is found from \hat{τ}=(π±\hat{φ})/ω₀, where ω₀=Tₛ.

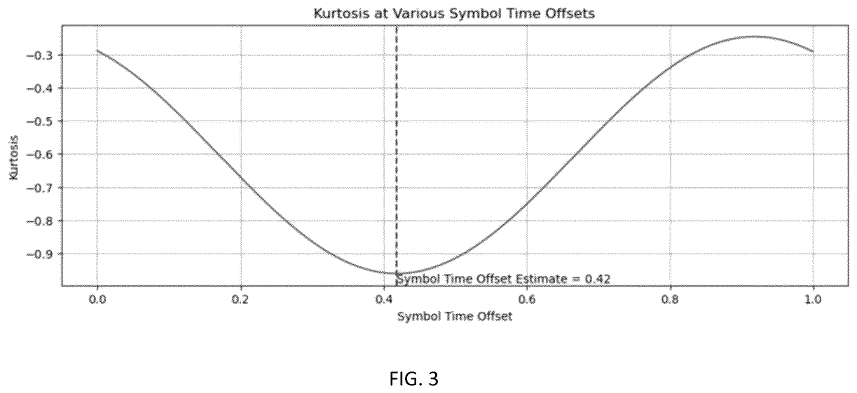

FIG. 3 is a graph showing calculated kurtosis values for a set of matched filter outputs obtained by filtering elements of a set of data blocks as shown in FIG. 2. Each of the matched filters used to generate the outputs corresponds to a different symbol timing offset value ϵ_{Δ}. The symbol timing offsets are shown on the horizontal axis in FIG. 3.

Calculated kurtosis values for the matched filter outputs are shown on the vertical axis. As illustrated by the graph, a delay value of ϵ_{Δ}=0.42 Tₛ yields the most negative kurtosis value, and therefore corresponds to the timing delay for which \hat{τ}−τ is most nearly zero.

Returning to FIG. 2, if the input data sequence to each matched filter is denoted as r(n) and each of the N matched filters 210₁ . . . 210_{N} is denoted p(nT−τᵢ), then the kurtosis of each matched filter output is calculated and the matched filter output having the most negative kurtosis value is selected according to

$${\hat{τ}}_{i} = {arg min}_{{τ}_{i}} \{ {\hat{C}}_{42} ( r ( n ) ) * p ( nT - {τ}_{i} ) ) \} \qquad [ 10 ]$$

In the determination of the complex kurtosis, complex magnitudes are used and so the absence of information about the phase and carrier offset does not affect the estimate of the delay τ. In contrast, in some conventional time delay and phase estimation techniques, estimates for the time delay and phase offset are generated in alternating fashion in a joint computational algorithm. Consequently, the convergence of one estimate affects the convergence of the other estimate, and it is possible that a slowly converging estimate for the phase offset, for example, will yield a slowly converging estimate for the time delay (or vice versa), resulting in significant loss of information from an incoming symbol stream while the algorithm proceeds toward convergence. It is also possible that a failure of one estimate to converge (e.g., the phase offset) may prevent the other estimate from converging as well (e.g., the time delay). The foregoing kurtosis-based procedure avoids these convergence-related problems and typically provides a faster estimate for \hat{τ} that is not dependent on estimates for other parameters.

Following determination of the estimate for \hat{τ}, estimates for two variables remain to be determined: the residual carrier frequency offset ω_{Δ} and the phase offset φ. The Viterbi and Viterbi algorithm can be used to obtain the coarse carrier frequency offset. Fourier transform methods can also be used for this purpose. However, typically after using these methods, there remains some residual frequency offset. This residual carrier frequency offset can be referred to as γ_{Δ}=ω_{Δ}−\hat{ω}_{Δ}.

If desired, the residual carrier frequency offset can be determined and corrected for using a variety of methods. In practice, the particular method used (or combination of methods) may depend upon the type of signal and/or signal structure. Data-based techniques estimate the frequency offset from the repetition of the same data frame by maximum likelihood. Other techniques involve taking the fourth-power of the received data and measuring the spectrum to get the frequency offset estimate. Both of these methods are affected equally by increases in noise level and give satisfactory estimations under 0.5% frequency offset values. In communication systems as OFDM, a preamble is used for both channel and frequency offset estimation. Only data-based estimation techniques are used to estimate the frequency offset with a preamble, since pilot tones are used in such methods.

Non-data-aided feed-forward frequency offset estimators have also been used, and the common feature of these algorithms is reliance on cyclostationary statistics of the received waveform. In particular, the phase-lock loop (PLL) is a widely used method for extracting the frequency and phase of received signals in both stationary and high dynamic scenarios. However, in some implementations, the PLL's performance can be limited by two factors: the trade-off between fast acquisition time and accurate phase extraction, and compromised performance for low SNR signals.

When both ϵ_{Δ} and γ_{Δ} are zero, the remaining term from Equation (9) characterizing the matched filter output is y(l)=yₗ=sₗ·e^{-jφ}. This is interpreted as a rotation in φ and can be expanded into complex form, yₗ=y_{l,re}+jy_{l,im}, as:

$${y}_{l} = [ {s}_{l , re} cos ( φ ) - {s}_{l , im} sin ( φ ) ] + j [ {s}_{l , re} sin ( φ ) + {s}_{l , im} cos ( φ ) ] \qquad [ 11 ]$$

where the subscripts re and im denote the real and imaginary components, respectively. This expansion can be rewritten in matrix form as:

$${\overline{y}}_{l} = [ \begin{matrix}{y}_{l , re} \\ {y}_{l , im}\end{matrix} ] = [ \begin{matrix}cos φ & - sin φ \\ sin φ & cos φ\end{matrix} ] [ \begin{matrix}{s}_{l , re} \\ {s}_{l , im}\end{matrix} ] = R ( φ ) \overline{{s}_{l}} \qquad [ 12 ]$$

where R(φ) is a rotation matrix.

The phase estimate \hat{φ} that is selected minimizes the sum of the kurtosis of the real and imaginary components, thereby generating a matched filter output that is not phase-rotated. The objective function J(φ) is therefore defined as the sum of those components as follows:

$$J ( φ ) = {C}_{40 , {y}_{l , re}} + {C}_{40 , {y}_{l , im}} \qquad [ 13 ]$$

The kurtosis of the real and imaginary components can be calculated from Equation (6). Substitution into Equation (13) yields:

$$J ( φ ) = 𝔼 [ {( c ( φ ) {y}_{l , re} + s ( φ ) {y}_{l . im} )}^{2} ] - 3 {𝔼 [ {( c ( φ ) {y}_{l , re} + s ( φ ) {y}_{l . im} )}^{2} ]}^{2} + 𝔼 [ {( - s ( φ ) {y}_{l , re} + c ( φ ) {y}_{l . im} )}^{2} ] - 3 {𝔼 [ {( - s ( φ ) {y}_{l , re} + c ( φ ) {y}_{l . im} )}^{2} ]}^{2} \qquad [ 14 ]$$

Equation (14) can then be written in compact form as

$$J ( φ ) = {W}_{1} [ {c ( φ )}^{4} + {s ( φ )}^{4} ] + {W}_{2} {c ( φ )}^{3} s ( φ ) + {W}_{3} {c ( φ )}^{2} {s ( φ )}^{2} + {W}_{4} c ( φ ) {s ( φ )}^{3} \qquad [ 15 ]$$

with the following definitions:

$${W}_{1} = 𝔼 ( {y}_{l , re}^{4} ) - 3 {𝔼 ( {y}_{l , re}^{2} )}^{2} + 4 𝔼 ( {y}_{l , im}^{4} ) - 3 {𝔼 ( {y}_{l , im}^{2} )}^{2}$$

$${W}_{2} = 4 𝔼 ( {y}_{l , re}^{3} {y}_{l , im} ) - 4 𝔼 ( {y}_{l , re} {y}_{l , im}^{3} ) - 12 𝔼 ( {y}_{l , re}^{2} ) 𝔼 ( {y}_{l , re} {y}_{l , im} ) + 12 𝔼 ( {y}_{l , im}^{2} ) 𝔼 ( {y}_{l , re} {y}_{l , im} )$$

$${W}_{3} = 12 𝔼 ( {y}_{l , re}^{2} {y}_{l , im}^{2} ) - 12 𝔼 ( {y}_{l , re}^{2} ) 𝔼 ( {y}_{l , re} {y}_{l , im} )$$

$${W}_{4} = 4 𝔼 ( {y}_{l , re} {y}_{l , im}^{3} ) - 12 𝔼 ( {y}_{l , re} {y}_{l , im} ) 𝔼 ( {y}_{l , im}^{2} ) - 4 𝔼 ( {y}_{l , re}^{3} {y}_{l , im} ) + 12 𝔼 ( {y}_{l , re}^{2} ) 𝔼 ( {y}_{l , re} {y}_{l , im} )$$

$$c ( φ ) = cos ( φ )$$

$$s ( φ ) = sin ( φ )$$

To determine an estimate for \hat{φ}, we set the gradient of J(φ) with respect to φ equal to zero and solve for φ=\hat{φ}:

$$\frac{\partial J ( \hat{φ} )}{\partial ( \hat{φ} )} = {W}_{1} [ 4 {s ( \hat{φ} )}^{3} c ( \hat{φ} ) - 4 {c ( \hat{φ} )}^{3} s ( \hat{φ} ) ] + {W}_{2} [ {c ( \hat{φ} )}^{4} - 3 {s ( \hat{φ} )}^{2} {c ( \hat{φ} )}^{2} ] + {W}_{3} [ - 2 c ( \hat{φ} ) {s ( \hat{φ} )}^{3} + 2 {c ( \hat{φ} )}^{3} s ( \hat{φ} ) ] + {W}_{2} [ 3 {c ( \hat{φ} )}^{2} {s ( \hat{φ} )}^{2} - {s ( \hat{φ} )}^{4} ] = 0 \qquad [ 16 ]$$

To obtain the estimate for \hat{φ}, an initial estimated value is used to seed the gradient descent algorithm. On each iteration, a multiple of the gradient in Equation (14) is subtracted from the previous iteration's estimate of \hat{φ} to generate a new estimate. In other words, successive estimates for \hat{φ} are generated as follows:

$${\hat{φ}}_{i + 1} = {\hat{φ}}_{i} - λ \frac{\partial J ( {\hat{φ}}_{i} )}{\partial {\hat{φ}}_{i}} \qquad [ 17 ]$$

In Equation (17), i indexes the iterations of the algorithm and λ is an adjustable parameter that can be selected as desired to control the rate of descent. For a smoothly varying, convex function with a single local minimum, λ can be comparatively larger provided it does not lead to overshooting the minimum. For a function that is not fully convex, λ may be selected to be smaller.

The algorithm terminates when successive estimates for \hat{φ} converge such that the change in the estimated value of \hat{φ} from one iteration to the next is less than a threshold value.

When φ=\hat{φ}, the output real and imaginary components of the matched filter do not contribute to interference among symbols. Because the kurtosis is calculated for the real and imaginary components of the matched filter output (which are real numbers), the real kurtosis rather than the complex kurtosis is determined for each component. As is evident from Equation (9), when φ=\hat{φ}, the components of y(m) are not mixed, so the sum of the real kurtosis of the real and imaginary components of y(m) is maximally negative.

The methods described in connection with FIG. 2 for determining the time delay ϵ_{Δ} that eliminates intersymbol interference involves N different matched filters and calculations of N complex kurtosis values for each of the filter outputs, for M data blocks of N symbols. If the blocks are not contiguous, it is possible that abrupt changes in \hat{τ} and/or \hat{φ} may occur, which may affect the successful selection of the optimum time delay.

To address this possible outcome, alternative methods can be used to determine the optimum value of the time delay such that \hat{τ}−τ is most nearly zero. As noted above, sampling at different timing offsets for a symbol, and averaging over a number of symbols, generates a distribution of kurtosis values. Kurtosis can be regarded as a convex function, and this property can be exploited for parameter estimation.

In particular, by determining two estimated kurtosis values for each symbol and under the assumption that kurtosis is a convex function, a gradient search can be used to determine the most negative kurtosis value and the corresponding time delay that produces the most negative kurtosis value. For each pair of calculated kurtosis values, the value which progresses furthest toward the most negative portion of the convex kurtosis distribution is selected and the corresponding time delay is used to iteratively update the estimate of \hat{τ}. The process repeats iteratively to find the most negative kurtosis value for the distribution, and therefore, the optimized value of \hat{τ}.

Minimization of an n-dimensional function depends on a comparison between functional values at (n+1) vertices of a general simplex followed by replacement with the most positive kurtosis value with another point. The simplex adjusts to the curve of convexity of the kurtosis, iteratively following the kurtosis toward convergence at its most negative value (e.g., at the minimum on the convex kurtosis curve). The simplex technique, applied to determination of minimum kurtosis, involves continually contracting down the kurtosis curve to estimate the symbol time offset. To perform each iteration, it is important to know whether the minimum is being approached from the curve's left or right side.

Two points, P₁ and P₂, are used for simplex-based determination of the minimum kurtosis value. In general, Kᵢ is used to denote the kurtosis function value at point i (i=1, 2). Further, yₕ=max (Kᵢ) is the value of y corresponding to the larger of the two values of the kurtosis function, and corresponding to the larger of the two values of the kurtosis function, and yₗ=min (Kᵢ) is the value of y corresponding to the smaller of the two values of the kurtosis function. The step size for each update of yₗ and yₕ can be adaptively adjusted and is denoted nₛ.

The simplex-based method uses neither gradients (first-order derivatives) nor quadratic forms (second-order derivatives). All of the algebraic operations are linear since the expectation operator is a linear operator for random variables, which are real-valued functions in the sample space, and therefore can be added and multiplied separably.

If we denote p(t) as a unit-energy pulse shaping function satisfying the Nyquist zero intersymbol interference theorem (e.g., a square root raised cosine function), and further assume that the function p(t) is symmetric, then the matched filters can be represented as p(t). The baseband input signal to the matched filters is denoted as b(n), where n={0, 1, . . . , Q} and Q is the length of the pulse-shaping matched filter; for this baseband input signal, b(n)=b(t) for all t=nT. Tis the upsampled value T=Tₛ/ζ, with 1/Tₛ representing the number of symbols transmitted per second, and ζ is an integer.

The pulse shaping function is assumed to be of finite duration (β−1)T, where β is an integer and is the number of samples in each pulse. If the autocorrelation peak occurs at time t=(β−1)/T, corresponding to sample n=(β−1), then p(t) and its matched filter is causal. The sampled matched filter has a total delay of τ_{N} such that for causal pulses pᵢ(n)=p(nT−τᵢ); n=0, 1, . . . , (β−1), and i=0, 1, . . . , τ_{N-1}.

Kurtosis values are determined at two different timing index estimates, idx1 and idx2. The two indices indicate the delay of the matched filter being used and are associated with delay estimates τ_{idx1} and τ_{idx2}. The number of input samples convolved with the matched filters, p_{idx1} and p_{idx2}, respectively, is L=β+(κ_{N}−1)ζ, where κ_{N} is the number of symbols used to estimate kurtosis.

The kurtosis values Kᵢ are calculated from the downsampled output of the matched filters, as described above in connection with Equation (7). If index idx1 indexes the delay of the most negative kurtosis value, that kurtosis value is retained and the downsampled matched filter output is retained. The other index idx2 is adjusted by nₛ steps to attempt to move to a smaller kurtosis value on the next iteration.

To determine whether the procedure has converged or stalled, the variance in the index changes can be calculated and compared to a threshold value. The procedure continues until the calculated variance indicates convergence or until convergence does not appear possible based on a comparison with the threshold value.

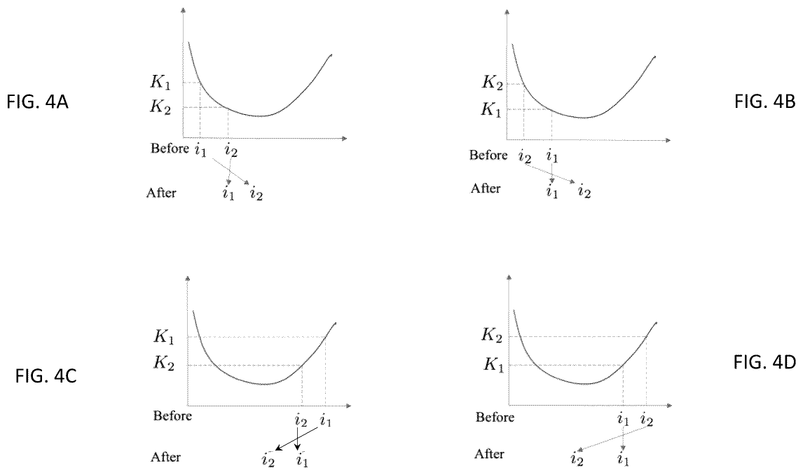

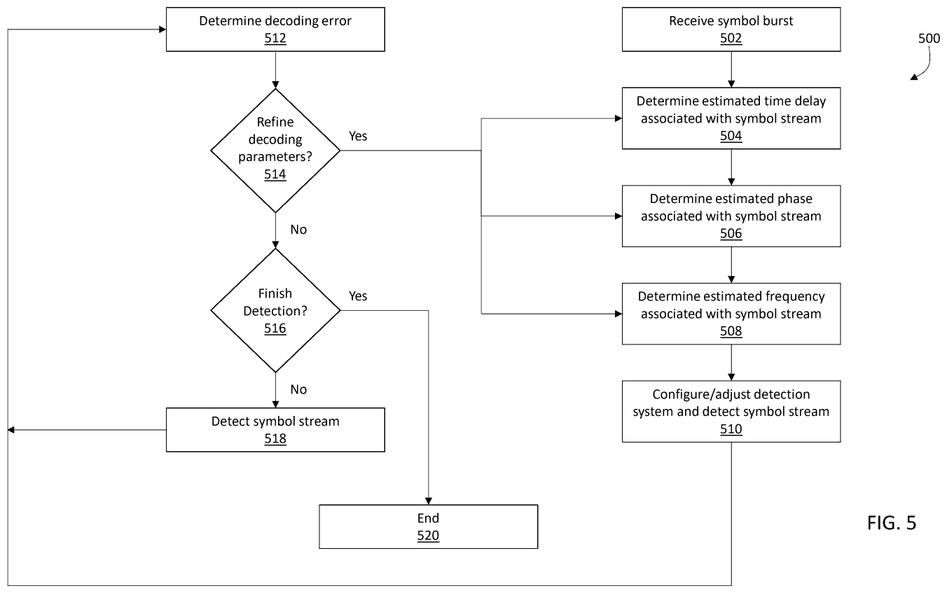

FIGS. 4A-4D are graphs representing four different cases, with kurtosis values K₁ and K₂ calculated at delay indices i₁ and i₂, respectively. In case 1 shown in FIG. 4A, K₁>K₂, so index i₁ is updated to the index value of i₂ for the next iteration, and index i₂ is adjusted by some number of index steps nₛ for the next iteration. Typically, nₛ is a relatively small integer (say, 2 or 3), with a value chosen as desired to control the rate of gradient descent toward the most negative kurtosis (and corresponding index).

In case 2 shown in FIG. 4B, K₂>K₁, so the index value of i remains the same for the next iteration and the index value i₂ is adjusted by nₛ index steps. In case 3 shown in FIG. 4C, K₁>K₂, so the index value i₁ is updated to the current index value i₂ for the next iteration, and index i₂ is adjusted by nₛ index steps for the next iteration. In case 4 shown in FIG. 4D, K₂>K₁, so the index value of i₁ remains the same for the next iteration and the index value i₂ is adjusted by nₛ index steps.

As is evident from FIGS. 4A-4D, if i₁ already indexes the delay of minimum kurtosis, i₂ shifts back and forth between i₁−nₛ and i₁+nₛ with i₁ remaining at delay τᵢ₁, the delay which yields the minimum kurtosis value. When i₂ cycles back and forth in this manner, the procedure can be terminated as the value for \hat{τ} is the delay associated with index i₁. Following convergence, the time index of the sequence of matched filter outputs with the lowest kurtosis value is designated as the time index associated with the delay for which \hat{τ}−τ is most nearly zero.

In some embodiments, nₛ remains constant through convergence to identify \hat{τ}. Alternatively, in certain embodiments, nₛ is adjusted such that among iterations toward convergence, the step-size by which index i₂ is adjusted is variable. As described above, one method for dynamically adjusting the value of nₛ involves calculating the variance of the change in index values after each iteration. When the variance is less than a threshold value, it suggests that the algorithm is converging toward a steady-state value for the minimum kurtosis. In these circumstances, the value of nₛ is decreased, provided that nₛ>1, which reduces the jitter of the algorithm as it converges. Adjustment of nₛ in this manner can lead to more rapid convergence compared with maintaining a constant value of nₛ. The algorithm can be tuned by adjusting the threshold value of the variance, which determines whether nₛ is adjusted at each iteration.

During iterations of the algorithm, if the index (i.e., either in or i₂) falls outside the range 0, 1, . . . , τ_{N-1}, the index is reduced modulo TN. However, to preserve the relative directional ordering between i₁ and i₂, this reduction only occurs if both i₁ and i₂ fall outside the above range-both are reduced.

The two-point technique described above is not the only method by which the minimum kurtosis value and the corresponding time delay can be determined. Other techniques can also be used for this purpose. For example, in some embodiments, the minimum kurtosis value can be determined by calculating kurtosis values corresponding to a set of matched filters of differing time delays, and then applying a regression analysis to determine a linear or nonlinear curve of best fit to the kurtosis values. The curve of best fit resulting from this procedure has an associated functional form that is parameterized from the regression analysis. The second-order derivative of this functional form can be calculated and used to find the convex kurtosis curve's minimum point (i.e., the most negative kurtosis value), and the time delay corresponding to the curve minimum.

In certain embodiments, quadratic interpolation of spectral peaks can be used to find the minimum kurtosis value. In gradient descent minimization methods, the next approximation to the minimum is determined iteratively by calculating a function's gradient at the current point, scaling the gradient by a learning rate a, and subtracting the scaled gradient from the current position. First-order gradient descent and least-squares methods may not converge at the global minimum where a function does not change monotonically, and instead has certain features such as saddle points. Second-order methods can then be used to overcome stalling at a non-minimum kurtosis value. For example, Newton-Raphson methods can be used to displace the stalled minimization procedure from a local minimum which is not a global minimum.

As another alternative, when the process of finding the minimum kurtosis value has not converged at the global minimum value, quadratic interpolation of spectral peaks can be used to displace the stalled minimization procedure from a local minimum (or to perform the minimization entirely). In this method, the functional form (in this instance, the kurtosis function) is sampled by determining kurtosis values K1, K2, and K3 at three time delay points designated p1, p2, and p3. The kurtosis value at the peak, K, represents the next approximation to the minimum kurtosis at time delay point p along the kurtosis curve, and is determined from the values at points p1, p2, and p3 as:

$$K = \frac{K 1 - K 3}{2 ( K 1 - 2 K 2 + K 3 )} \qquad [ 18 ]$$

It should also be noted that in some embodiments, estimated values of the timing delay \hat{τ} and/or carrier frequency \hat{ω} can be determined using gradient descent techniques that are similar to those described above in connection with determining an estimate for \hat{φ}. In general, gradient descent techniques can be applied to determine estimates of any of the parameters of a symbol stream discussed herein.

The various methods described herein can generally be combined in any manner to detect an incoming symbol stream. FIG. 5 is a flow chart 500 that shows a set of example steps that can be used to identify parameters associated with the symbol stream for detection and decoding purposes. In step 502, a brief symbol burst is detected by a receiver. The symbol burst is representative of a larger constellation of symbols—that is, it is encoded using the same encoding scheme, and the distributions of time delays, phases, and carrier frequencies associated with the symbol burst are representative of the larger constellation of symbols.

Next, in step 504, the time delay \hat{τ} associated with the symbol burst is determined. As discussed above, various methods can be used to estimate the value of \hat{τ}, including any of the methods (and combinations thereof) discussed herein. Regardless of the specific implementation, step 504 yields an estimate of the time delay \hat{τ}.

Then in step 506, the phase \hat{φ} associated with the symbol burst is determined. As with the time delay, one or more of multiple methods can be used to estimate the value of \hat{φ}. Suitable methods include, but are not limited to, any of the methods (including combinations thereof) discussed herein. Step 506 yields an estimate of the phase \hat{φ}.

In step 508, the carrier frequency \hat{ω} associated with the symbol burst is determined. As above, a variety of different methods can be used in this step including, but not limited to, the methods discussed herein (and combinations thereof). Step 508 yields an estimate of the carrier frequency \hat{ω}.

Next, in step 510, the receiver (or more generally, a detection system that includes the receiver) is optionally configured or adjusted based on values of the time delay, phase, and carrier frequency determined in steps 504, 506, and 508, and an incoming symbol stream is detected. The configuration or adjustments can be applied to a hardware-based detector such as an antenna (or an array of antennas), to one or more processors that decode the symbol stream, or to a combination of a detector and one or more processors.

Typically, for example, the detection system includes a signal de-modulator that performs demodulation of the incoming symbol stream to extract information from the detected symbols. The estimates of timing delay, phase offset, and/or frequency offset that are determined according to the methods described herein are used to configure the de-modulator to perform this de-modulation by synchronizing the de-modulator to the incoming symbol stream. As noted previously, because the methods described herein can be used to obtain estimates of these parameters without lengthy sampling of the incoming symbol stream, a greater fraction of the symbol stream can be detected and the encoded information therein recovered, relative to other blind parameter estimation methods which rely on repeated/extensive sampling and iterative parameter refinement based on such sampling.

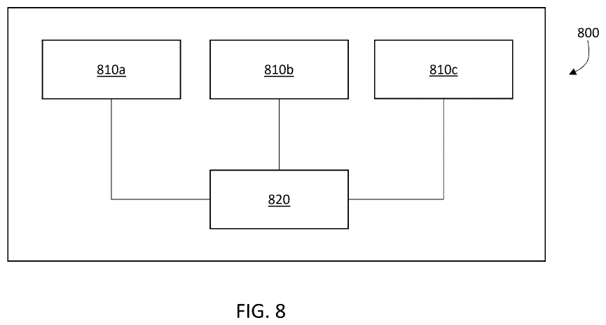

FIG. 8 is a schematic diagram showing an example of a signal demodulator 800 that is part of a detection system. As noted above, the detection system can generally include one or more antennas, detection arrays, or more generally, signal receivers (such as signal receiver 100). The signal receivers can detect incoming symbol streams in a variety of different wavelength bands. For satellite-based signal transmission and reception, radio-wave and microwave bands are particularly useful for encoding symbol streams. More generally, however, symbols in a wide variety of different bands within the electromagnetic system can be used.

Signal demodulator 800 includes one or more detection elements 810a, 810b, 810c, . . . coupled to a demodulation controller 820. Demodulation controller 820 generates control signals for each of the detection elements. In turn, detection elements 810a, 810b, 810c, . . . receive raw electrical signals from the signal receivers of the detection system and process the raw signals to deliver detected symbol streams. In the example shown in FIG. 8, a single demodulation controller 820 is used to provide control signals to multiple detection elements. In some embodiments, each detection element has a dedicated demodulation controller that provides control signals for only that detection element.

Detection elements typically consist of signal processing components such as filters, gates, transistors, logic elements, and other analog and digital components. Demodulation controller 820 is generally implemented as an electronic processor, a programmable circuit, an application-specific integrated circuit (ASIC), or any of the other controller types described herein (e.g., controller 603).

In a conventional detection system, each of the detection elements 810a, 810b, 810c . . . generates a “processed” symbol stream that either consists of the raw electrical signals received from the signal receivers of the detection system, or a symbol stream that is filtered according to a predetermined set of filtration parameters (including, for example, values for symbol frequency and timing). As explained above, however, such predetermined filtration parameters are rarely sufficient for accurate and rapid detection of symbol streams transmitted in burst mode. More commonly in conventional systems, raw electrical signals or signals processed according to a predetermined set of parameters are transmitted to downstream processing algorithms which attempt to extract parameters such as symbol frequency and time delay from the raw symbol stream, using methods such as Fourier analysis. For symbol streams processed in burst mode, a significant amount of information is lost before symbol stream parameters can be estimated, and the effects of noise contributions to the detected signals are difficult to compensate.

In the present systems, information about the estimated frequency and/or estimated time delay and/or estimated phase of a symbol stream is transmitted by a system controller (e.g., controller 603) to demodulation controller 820 and used to configure detection elements 810a, 810b, 810c, . . . to process the incoming electrical signals corresponding to a symbol stream. In this manner, an improved demodulator 800, configured according to the decoding parameters determined as described herein (and shown for example in FIG. 5), is the result.

Use of the configured demodulator 800 to detect and analyze a subsequent symbol stream provides a number of important advantages. For example, by modifying demodulator 800 based on the decoding parameters, demodulator 800 exhibits improved ability to track symbol streams from one or more different signal sources. Additionally, relative to conventional methods for symbol stream detection, comparatively less information is lost while the system attempts to lock on to a symbol stream; that is, decoding parameters can be determined more efficiently and accurately than is possible using conventional methods, thereby increasing the amount of information that is recovered, particularly from symbol streams transmitted in burst mode. This advantage is particularly pronounced when decoding parameters are re-determined multiple times, as each execution of the methods described herein results in additional information recovery relative to conventional signal tracking methods.

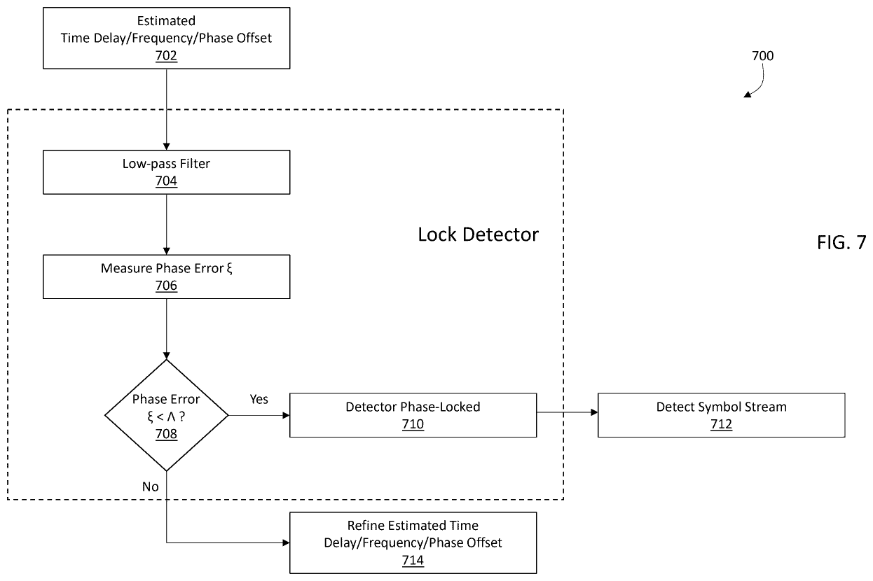

In some embodiments, information from the detection system can be used to determine whether additional refinement of the timing delay, phase offset, and/or frequency offset should be performed. FIG. 7 is a flow chart 700 showing a set of example steps that can be performed following step 510 in FIG. 5 to determine whether the parameter values estimated in steps 504-508 should be refined further.

Certain steps in FIG. 7 can be performed by a lock detector (indicated in the dashed line in the figure) or by a controller connected to a lock detector. The lock detector maintains a lock on the symbol timing, frequency offset, and the phase offset of an incoming signal for detection. Maintaining lock maintains a track on these parameters. If lock synchronization is lost, the detection system may not be able to de-modulate (and therefore decode) an incoming symbol stream.

De-modulation of the symbols is the process of associating a symbol's characteristics to its defined position in a two-dimensional mapping point typically represented by a complex number representation in particular instances of m-ary PSK modulations. For other modulations such as m-ary PAM, scalar number representation can be employed. The complex or scalar value can then be transformed to the appropriate bit representation. The bit stream generated is the original transmitted data message that is further processed by a forward error correction algorithm for correcting bit errors caused by channel impairments such as lightning or artificial interference. The absence of detector lock and synchronization to the symbol may cause the detected symbol value to be incorrect relative to its true value, and may therefore produce incorrect bit mapping from the symbol constellation.

The lock detector shown in FIG. 7 can be used to determine whether the estimation of parameters in steps 504-508 allows the detection system to maintain synchronization with, and therefore coherently track, an incoming symbol stream. Absent suitable synchronization, adjustments to the estimated parameter values can be made to correct timing delay, phase offset, and/or frequency offset (for example, to a higher resolution if necessary). If these additional adjustments do not further improve synchronization, it can be determined that some other component or aspect of the detection system is working improperly, or the signal to noise ratio of the incoming symbol stream is below the sensitivity threshold of the detection system.

In FIG. 7, the estimated time delay, frequency offset, and phase offset parameters are received by the lock detector in step 702. These parameter values are determined in steps 504-508 of FIG. 5 as described above. Next, in step 704, these parameter values are used to configure the detection system (as described in connection with step 510) and the detected symbol stream is low-pass filtered. The phase error ξ is determined in step 706 and compared to a threshold value Λ in step 708. If the phase error is less than the threshold value, then the detection system is determined in step 710 to be suitably phase-locked, and the detection system is used in step 712 to detect a portion of the incoming symbol stream.

Alternatively, if the phase error is larger than the threshold value in step 708, then in step 714 the estimated time delay and/or frequency offset and/or phase offset parameter values are refined (or even re-determined) to better synchronize the detection system to the incoming symbol stream. In some embodiments, for example, step 714 involves returning to step 504, 506, or 508 in FIG. 5. In certain embodiments, if sampling of the initial signal burst may be responsible for errors in the estimated values of the time delay and/or frequency offset and/or phase offset, control may return to step 502 in FIG. 5, where another symbol burst is received and then processed as described above.

In FIG. 7, when the lock detector is phase-locked, the closed-loop phase error is a small (possibly zero) constant phase. This phase-locked state is stable if small deviations from the constant small value dampen out with time. When the closed-loop phase error is larger than the threshold value, a false lock is indicated by the lock detector.

In some embodiments, an estimate of post-processing decoding error can be used to determine whether further refinement and/or re-determination of estimated parameter values determined in steps 504-508 may be warranted. For example, a redundancy checking sequence or other similar verification information may be encoded in the symbol stream that is detected, and can be decoded to determine whether the decoded sequence/information matches the known encoded sequence/information. Mismatches can be used as estimates of the decoding error, and can be used to prompt refinement and/or re-determination of estimated values of the timing delay, phase offset, and/or frequency offset.

Returning to FIG. 5, in optional step 512, an estimate of a decoding error is obtained, and then in optional step 514, the one or more error estimates determined in step 512 are compared with acceptable ranges associated with these estimates to determine whether the parameter values estimated in steps 504, 506, and/or 508 should be re-determined.

It should be understood that in certain embodiments, steps 512 and/or 514 are not performed. For example, the initial estimates of the parameters in steps 504, 506, and 508 may be only estimates of these parameters that are obtained. Alternatively, refinement of the initial estimates of the parameters obtained in steps 504-508 may be triggered by a lock detector as described in connection with FIG. 7, rather than by estimates of decoding errors.

In some embodiments, one or more of steps 504, 506, and 508 may be performed periodically, without being triggered by obtaining an estimate of a phase lock error or post-processing decoding error, to implement a periodic re-calibration of the detection system. As yet another alternative, some of the parameters obtained in steps 504, 506, and 508 may be re-determined after a phase lock error has been identified by the lock detector, and/or some of the parameters obtained in steps 504, 506, and 508 may be re-determined after obtaining an estimate of a decoding error and comparing the decoding error against a range of acceptable values, and/or some of the parameters obtained in steps 504, 506, and 508 may be re-determined automatically/periodically, without a triggering event. Configuring or adjusting a receiver or detection system remains an optional step under all implementations of the foregoing methods.

In FIG. 5, in step 514 if it is determined that one or more of the parameter values obtained in steps 504, 506, and/or 508 should be re-determined, control passes to one of steps 504, 506, and 508, as appropriate. If no parameter re-determinations are to be performed, control passes to step 516. At step 516, if the symbol stream has been fully detected, control passes to step 520 where the procedure ends. Alternatively, if the symbol stream has not been fully detected, additional symbols are detected in step 518 and then control returns either to optional step 512, or to step 516.

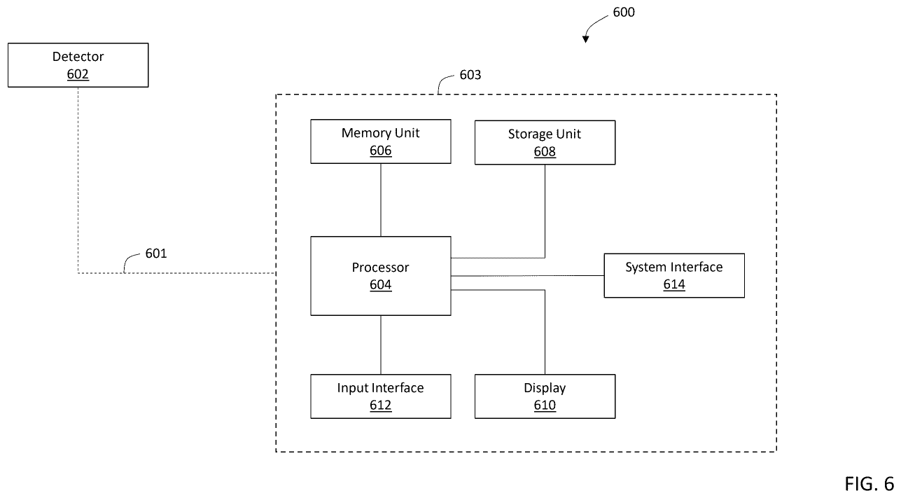

The methods described herein can be performed using detection systems that incorporate a wide variety of different hardware components. FIG. 6 shows one example of a suitable detection system 600 for executing the procedures discussed above. System 600 includes a detector 602 that is coupled to a controller 603 that includes a processor 604, a memory unit 606, a storage unit 608, a display 610, an input interface 612, and a system interface 614. It should be understood that implementations of controller 603 can also include any one or more of the above components in multiplicity. For example, controller 603 can include multiple processors 604, multiple memory units 606, multiple storage units 608, multiple system interfaces 614, etc. Merely to simplify the discussion below, each of the above elements is referred to as a single element.

Controller 603 is coupled to detector 602 via a communication interface 601. Interface 601 can be a physical, wired interface (i.e., one or more communication lines). Alternatively, interface 601 can be a wireless connection between detector 602 and controller 603. Still further, in some embodiments, a combination of wired and wireless interfaces between detector 602 and controller 603 form communication interface 601.

Detector 602 can be implemented in a variety of ways. In general, detector 602 includes hardware components suitable for receiving a stream of symbols from a symbol constellation, and converting the symbol stream into a signal that is processed by controller 603. Suitable detectors for this purpose include, but are not limited to, one or more antennas, including phased arrays of antennas. As described previously, detector 602 can also include one or more signal demodulators (e.g. demodulator 800) which are configured to receive control instructions from controller 603.

Processor 604 can process instructions for execution within the controller 603, including instructions stored in the memory unit 606 or in the storage unit 608. For example, the instructions can instruct processor 604 to perform any of the various steps described herein.

Memory unit 606 can store executable instructions for processor 604, information about parameters of the system and of the symbol stream (such as estimated values of the parameters determined in the various methods described herein). Storage unit 608 can be a computer-readable medium, such as a floppy disk device, a hard disk device, an optical disk device, or a tape device, a flash memory or other similar solid state memory device, or an array of devices, including devices in a storage area network or other configurations. Storage device 608 can store instructions that can be executed by processor 604 as described above, and any of the other information that can be stored by memory unit 606.

In some embodiments, controller 603 can include a graphics processing unit to display graphical information (e.g., using a GUI or text interface) on an external input/output device, such as display 610. A user can use input devices (e.g., keyboard, pointing device, touch screen, speech recognition device) as part of input interface 612 to provide input to controller 603. In some embodiments, one or more such devices are part of input interface 612.

The methods disclosed herein can be implemented by controller 603 by executing instructions in one or more computer programs that are executable and/or interpretable by controller 603, and specifically, by processor 604 of controller 603. These computer programs (also known as software, software applications or code) include machine instructions for a programmable processor, and can be implemented in a high-level procedural and/or object-oriented programming language, and/or in assembly/machine language. For example, computer programs can contain the instructions that can be stored in memory unit 606, in storage unit 608, and/or on a tangible, computer-readable medium, and executed by processor 604 as described above. As used herein, the term “computer-readable medium” refers to any computer program product, apparatus and/or device (e.g., magnetic discs, optical disks, memory, programmable logic devices (PLDs), application-specific integrated circuits (ASICs), and electronic circuitry) used to provide machine instructions and/or data to a programmable processor, including a machine-readable medium that receives machine instructions.

By executing instructions as described above (which can optionally be part of controller 603), the controller can be configured to implement any one or more of the various steps described in connection with any of the procedures discussed herein.

The various techniques described herein have been discussed in the context of electromagnetic signals, and in particular, signals that are used in communication applications. The techniques can be used in other applications as well and/or for detecting other types of signals, such as in general signal monitoring applications. For example, the techniques can be used for detection of non-communication electromagnetic signals, i.e., electromagnetic signals that are transmitted for purposes other than communication between and transmitter and receiver. The techniques can also be used with acoustic signals, e.g., for detecting sonar and other acoustic waves received by a detector.

### OTHER EMBODIMENTS

While certain embodiments of the present disclosure have been shown and described herein, it will be obvious to those skilled in the art that such embodiments are provided by way of example only. Numerous variations, changes, and substitutions will be apparent to those skilled in the art. It should be understood that various alternatives to the embodiments specifically described herein are within the scope of this disclosure.

What is claimed is:

1. A system, comprising:
a receiver configured to detect signals corresponding to a stream of digital symbols;
a signal demodulator coupled to the receiver and configured to process an incoming stream of digital symbols; and
a computing device connected to the receiver and to the signal demodulator, and comprising a set of software instructions that, when executed by the computing device, causes the computing device to:
determine an estimated time delay associated with the stream of digital symbols by:
(a) for at least a first subset of the stream of digital symbols, determining two kurtosis values associated with the subset of the stream of digital symbols, wherein the first kurtosis value is associated with a first time delay value and the second kurtosis value is associated with a second time delay value different from the first time delay value;
(b) selecting either the first or second time delay value according to the smallest associated kurtosis value;
(c) selecting a new time delay value to replace either the first or second time delay that is not selected in step (b);
(d) repeating steps (a)-(c) to determine the time delay value associated with a minimum kurtosis value among all time delays within a sampling range of time delay values; and
(e) identifying the time delay value associated with the minimum kurtosis value as the estimated time delay;
transmit control instructions to the signal demodulator to configure the signal demodulator according to the estimated time delay; and
process at least a second subset of the stream of digital symbols using the configured signal demodulator.

2. The system of claim 1, wherein the set of software instructions, when executed by the computing device, causes the computing device to:
determine a variance of the selected time delay values; and
identify the time delay value associated with the minimum kurtosis value as the estimated time delay based on a comparison between the determined variance and a threshold value of the variance.

3. The system of claim 1, wherein the set of software instructions, when executed by the computing device, causes the computing device to:
determine an estimated phase associated with the stream of digital symbols; and
transmit control instructions to the signal demodulator to configure the signal demodulator according to the estimated phase.

4. The system of claim 3, wherein the set of software instructions, when executed by the computing device, causes the computing device to determine the estimated phase by:
for at least a subset of the stream of digital symbols, calculating real and imaginary components of a kurtosis for a plurality of different phase values; and
selecting the value of the phase that yields a minimum value of a sum of real and imaginary components of the kurtosis as the estimated phase.

5. The system of claim 4, wherein the set of software instructions, when executed by the computing device, causes the computing device to select the value of the phase that yields a minimum value of a sum of real and imaginary components of the kurtosis by performing a gradient descent minimization to determine the minimum value of the sum of real and imaginary components of the kurtosis.

6. The system of claim 1, wherein the set of software instructions, when executed by the computing device, causes the computing device to:
determine an estimated frequency associated with the stream of digital symbols; and
transmit control instructions to the signal demodulator to configure the signal demodulator according to the estimated frequency.

7. The system of claim 6, wherein the set of software instructions, when executed by the computing device, causes the computing device to determine the estimated frequency by:
for at least a subset of the stream of digital symbols, calculating real and imaginary components of a kurtosis for a plurality of different frequency values; and
selecting the value of the frequency that yields a minimum value of a sum of real and imaginary components of the kurtosis as the estimated frequency.

8. The system of claim 1, wherein processing the at least a second subset of the stream of digital symbols using the configured signal demodulator comprises extracting information from the at least a second subset of the stream of digital symbols.

9. The system of claim 3, wherein the computing device determines the estimated phase from the first subset of the stream of digital symbols.

10. The system of claim 3, wherein the computing device determines the estimated phase from a third subset of the stream of digital symbols.

11. The system of claim 3, wherein the set of software instructions, when executed by the computing device, causes the computing device to:
process an additional stream of digital symbols using the configured signal demodulator; and
extract information from the additional stream of digital symbols.

12. The system of claim 6, wherein the set of software instructions, when executed by the computing device, causes the computing device to:
process an additional stream of digital symbols using the configured signal demodulator; and
extract information from the additional stream of digital symbols.

13. The system of claim 1, wherein the set of software instructions, when executed by the computing device, causes the computing device to:
determine a value of decoding error associated with the processed second subset of the stream of digital symbols; and
determine, based on the decoding error, whether to determine a new estimate for the time delay associated with the stream of digital symbols.

14. The system of claim 13, wherein the set of software instructions, when executed by the computing device, causes the computing device to:
repeat steps (a)-(e) for a fourth subset of the stream of digital symbols to determine a new estimate for the time delay associated with the stream of digital symbols; and
transmit control instructions to the signal demodulator to configure the signal demodulator according to the new estimated time delay.

15. A system, comprising:
a receiver configured to detect signals corresponding to a stream of digital symbols;
a signal demodulator coupled to the receiver and configured to process an incoming stream of digital symbols; and
a computing device connected to the receiver and comprising a set of software instructions that, when executed by the computing device, causes the computing device to:
determine an estimated time delay associated with the stream of digital symbols by:
(a) for at least a subset of the stream of digital symbols, filtering the subset of the stream of digital symbols according to a candidate time delay and determining a kurtosis value associated with the filtered subset of the stream of digital symbols;
(b) repeating step (a) to determine a plurality of kurtosis values associated with different candidate time delays; and
(c) identifying the candidate time delay value associated with the minimum calculated kurtosis value as the estimated time delay; and
transmit control instructions to the signal demodulator to configure the signal demodulator according to the estimated time delay; and
process at least a second subset of the stream of digital symbols using the configured signal demodulator.

16. The system of claim 15, wherein the set of software instructions, when executed by the computing device, causes the computing device to:
interpolate among the determined plurality of kurtosis values to identify a minimum kurtosis value that is smaller than any of the determined plurality of kurtosis values; and
identify a time delay value associated with the minimum kurtosis value as the estimated time delay.

17. The system of claim 15, wherein the set of software instructions, when executed by the computing device, causes the computing device to determine an estimated phase associated with the stream of digital symbols.

18. The system of claim 17, wherein the set of software instructions, when executed by the computing device, causes the computing device to determine the estimated phase by:
for at least a subset of the stream of digital symbols, calculating real and imaginary components of a kurtosis for a plurality of different phase values; and
selecting the value of the phase that yields a minimum value of a sum of real and imaginary components of the kurtosis as the estimated phase.

19. The system of claim 18, wherein the set of software instructions, when executed by the computing device, causes the computing device to select the value of the phase that yields a minimum value of a sum of real and imaginary components of the kurtosis by performing a gradient descent minimization to determine the minimum value of the sum of real and imaginary components of the kurtosis.

20. The system of claim 15, wherein the set of software instructions, when executed by the computing device, causes the computing device to determine an estimated frequency associated with the stream of digital symbols.

21. The system of claim 20, wherein the set of software instructions, when executed by the computing device, causes the computing device to determine the estimated frequency by:
for at least a subset of the stream of digital symbols, calculating real and imaginary components of a kurtosis for a plurality of different frequency values; and
selecting the value of the frequency that yields a minimum value of a sum of real and imaginary components of the kurtosis as the estimated frequency.

22. The system of claim 15, wherein processing the at least a second subset of the stream of digital symbols using the configured signal demodulator comprises extracting information from the at least a second subset of the stream of digital symbols.

23. The system of claim 17, wherein the set of software instructions, when executed by the computing device, causes the computing device to:
transmit control instructions to the signal demodulator to configure the signal demodulator according to the estimated phase; and
process the at least a second subset of the stream of digital symbols using the signal demodulator configured according to the estimated time delay and estimated phase.

24. The system of claim 20, wherein the set of software instructions, when executed by the computing device, causes the computing device to:
transmit control instructions to the signal demodulator to configure the signal demodulator according to the estimated frequency; and
process the at least a second subset of the stream of digital symbols using the signal demodulator configured according to the estimated time delay and estimated frequency.
